(19) United States
(12) Patent Application Publication
(10) Pub. No.: US 2011/0292666 A1
(43) Pub. Date: Dec. 1, 2011

(54) UNIVERSAL EBOOK READER, SMART PHONE, AND TABLET COMPUTER HOLDER

(75) Inventor: Kenneth John GALLAGHER, Anaheim, CA (US)

(73) Assignee: KENNETH JOHN GALLAGHER, ANAHEIM, CA (US)

(21) Appl. No.: 12/832,939

(22) Filed: Jul. 8, 2010

Related U.S. Application Data
(60) Provisional application No. 61/396,554, filed on May 28, 2010.

(51) Int. Cl. F16M 11/04; F16M 13/00; F16M 13/02; F21S 2/00; F16M 11/18

(52) U.S. Cl. 362/457; 248/160; 248/125.8; 248/220.21; 248/309.1

(57) ABSTRACT

The present invention concerns itself with a floor top holder for a device such as a tablet computer, comprising a floor base, a post, and one, two or more flexible tubes as a support and as a position adjustment mechanism. A wall version of the device holder is also the object of the present invention. Furthermore, the device holder invented can be easily converted from a floor base version to a wall, desk, or table top version.

### CROSS-REFERENCE TO RELATED APPLICATIONS

This application claims the benefit of U.S. Provisional Application No. 61/396,554, filed May 28, 2010, which is hereby incorporated by reference.

### BACKGROUND OF THE INVENTION

1. Field of the Invention

The present invention relates generally to accessories for electronic devices and particularly to systems and methods for supporting and positioning such devices.

2. Description of the Related Art

There is currently a considerable worldwide market for holders of smart phones and tablet computers. However, since the smart phone has been on the market much longer than the tablet computer has, it seems that the current amount of smart phone holders on the market vastly exceeds the amount of tablet computer holders. Also, since smart phones are smaller than tablet computers they are carried more often by people and carried to more places. There are smart phone holders currently for sale that will hold hands-free your smart phone for you while you are sitting at a table or desk, while you are on an airplane, or while you are driving your car, etc. And, there are tablet computer holders that currently will hold your tablet computer for you while you are at a desk or table. Also, there is an inexpensive tablet computer holder that is now on the market that holds your tablet computer on a wall.

While there are currently some smart phone holders (not tablet computer holders) on the market that use flexible tube, none of them rest on the floor. The current flexible tube smart phone holders that are on the market are either used in a car, or on a desk or table top, or have a clamp for a base that can be attached to anything that the clamp can be attached to. There are currently no flexible tube tablet computer holders on the market. And, there are currently no floor based tablet computer holders on the market. Therefore, the consumer has little or no choice when faced with the need of using their tablet computer or other similar devices in their homes or offices. Furthermore, the consumer currently does not have the option of using a system that can easily and quickly convert from a floor top version to a wall, desk, or table top version. These problems are solved by the present invention.

The problems and the associated solutions presented in this section could be or could have been pursued, but they are not necessarily approaches that have been previously conceived or pursued. Therefore, unless otherwise indicated, it should not be assumed that any of the approaches presented in this section qualify as prior art merely by virtue of their presence in this section of the application.

### BRIEF SUMMARY OF THE INVENTION

The present invention concerns itself with a floor top holder for a device such as a tablet computer, comprising a floor base, a post, and one, two or more flexible tubes as a support and as a position adjustment mechanism. A wall version of the device holder using one or more flexible tubes is also the object of the present invention. Furthermore, the device holder invented can be easily and conveniently converted from a floor base version to a wall, desk, or table top version. The quick connect/disconnect capability is a beneficial and economical solution for the users as they would not need to purchase a complete device holder for any space or location where they need to use the device.

### BRIEF DESCRIPTION OF THE DRAWINGS

For exemplification purposes, and not for limitation purposes, embodiments of the present invention are illustrated in the figures of the accompanying drawings, in which:

FIG. 1 illustrates the side view of a post 12 connected at its lower end to a base 11 and at its upper end to a coupling element 13, in accordance with an embodiment of the present invention.

FIG. 2 illustrates the side view of a flexible tube 21 having at each end a coupling element 22, in accordance with an embodiment of the present invention.

FIG. 3 illustrates the side view of a tablet computer holder with its mounting plate 35, flexible tube 31, coupling system 34, post 32 and base 33, in a sample user environment (i.e., bed proximity), in accordance with an embodiment of the present invention.

FIG. 4 illustrates the side view of flexible tube 41, with a coupling element 42 connected to pin 43 through its coupling element 47, at one end, and, at the other end of the flexible tube 41, a coupling element 46 connected to mounting plate 45 through connector 44, in accordance with an embodiment of the present invention.

FIG. 5 illustrates the partial side view of a tablet computer holder including flexible tube 51, coupling elements 52 and 57, post 58 and electrical cord 59, in accordance with an embodiment of the present invention.

FIGS. 6a and 6b illustrate alternative coupling methods of a tablet computer holder (partial view) with flexible tubes 61a and 61b, coupling elements 62a, 67a and 67b, electrical cords 69a and 69b, pins 610a and 610b, and, tubes 68a and 68b, in accordance with several embodiments of the present invention.

FIG. 7a and FIG. 7b illustrate a partial side view of a flexible tube 71 connected to mounting plate 75 through connector 74 and coupling element 76, and, a back view of connector 74 with its own coupling element 72 and holes 73, in accordance with an embodiment of the present invention.

FIG. 8 illustrate a partial side view of a flexible tube 81 connected to mounting plate 85 through a one-piece connector 84, in accordance with an embodiment of the present invention.

FIG. 9 illustrates the front view of a tablet computer 97 attached to a mounting plate 95 having a safety hole 98, and being connected to two flexible tubes 91, in accordance with an embodiment of the present invention.

FIG. 10 illustrates the side view of flexible tube 101, with a coupling elements 102 at one end, and, at the other end, a coupling element 106 connected to mounting plate 105 through connector 104 to which a second flexible tube (partial view) 120 is connected through coupling element 130, in accordance with an embodiment of the present invention.

FIG. 11 illustrates the partial side view of a dual flexible tube holder, wherein the flexible tubes 111 connect to a mounting plate 114 through coupling elements 112 and 113, the mounting plate 114 being connected to a pin 115, in accordance with an embodiment of the present invention.

FIG. 12 illustrates the side view of a tablet computer holder comprising the dual flexible tube system 121 connected to a first mounting plate 125 (i.e., for holding the tablet computer) and a second mounting plate 124 (i.e., for connection to the post 122), post 122, base 123 and wheels 126, in accordance with an embodiment of the present invention.

FIG. 13 illustrates the side view of a tablet computer holder comprising the triple flexible tube system 131 connected to a first mounting plate 135 (i.e., for holding the tablet computer) and a second mounting plate 134 (i.e., for connection to the post 132), post 132, base 133 and wheels 136, in accordance with an embodiment of the present invention.

FIGS. 14a, 14b and 14c illustrate the partial back view of a tablet computer holder (i.e., FIG. 14b) comprising the quadruple flexible tube system 141 connected to a first mounting plate 145 (i.e., for holding the tablet computer) and a second mounting plate 144 (i.e., for connection to the post 142), post 142 and base 143 (i.e., FIG. 14c), and, a top view (i.e., FIG. 14a) of base 146 and post 147, in accordance with an embodiment of the present invention.

FIG. 15 illustrates the side view of a base for a tablet computer holder to be used on a wall 151, the holder comprising wall mounting plate 152, vertical connector 154 and tube 153, in accordance with an embodiment of the present invention.

FIG. 16 illustrates the front view of a base for a tablet computer holder, to be used on a wall, comprising wall mounting plate 162 with mounting holes 161 and tube 163, in accordance with an embodiment of the present invention.

FIG. 17 illustrates a sample user environment (i.e., bedroom) where a wall version of the tablet computer holder may be used.

FIG. 18 illustrates the top view of a desk base 181 for the tablet computer holder, designed with four ports 182 to accommodate four flexible tubes, in accordance with an embodiment of the present invention.

FIG. 19 illustrates the side view of a desk and table top port station with two ports 192 and base 191 in accordance with an embodiment of the present invention.

FIG. 20a (top view), FIG. 20b (side view) and FIG. 20c (front view) illustrate the groove element 201, of a tongue and groove fastening system, attached to mounting plate 202 having a safety peg mounting hole 203 for a quick and safe fastening of the tablet computer to the mounting plate 202, in accordance with an embodiment of the present invention.

FIG. 21a (top view) and FIG. 21b (back view) illustrate the tongue element 211 of a tongue and groove fastening system attached to the back of a tablet computer 212, in accordance with an embodiment of the present invention.

FIG. 22a (top view), FIG. 22b (side view) and FIG. 22c (front view) illustrate the groove element 221, of a tongue and groove fastening system, with self-locking retractable peg arm 230 and peg 240, and attached to mounting plate 222 having a safety peg mounting hole 223, in accordance with an embodiment of the present invention.

FIG. 23a (top view) and FIG. 23b (back view) illustrate the tongue element 231 of a tongue and groove fastening system having a retractable peg locking hole 233 and being attached to the back of a tablet computer 232, in accordance with an embodiment of the present invention.

FIG. 24 illustrates the side view of a tablet computer 242b being attached to a mounting plate 242a through a tongue and groove system 241 and being secured by a self-locking retractable peg 240, in accordance with an embodiment of the present invention.

FIG. 25a (front view), FIG. 25b (top view) and FIG. 25c (side view) illustrate a channel 251, for a device to be slid into, attached to mounting plate 252 which has a safety peg 270 installed, in accordance with an embodiment of the present invention.

FIG. 26 illustrates the side view of a decorative rubber boot 261 for covering the tube-to-plate connector assembly (not seen), in accordance with an embodiment of the present invention.

FIG. 27a (top view) and FIG. 27c (back view) illustrate a safety system for a holder of a tablet computer 271 being comprised of Velcro stripes 272, sticky taped plastic sheet 273 with opening 278, safety strap 276 attached to mounting plate 274 through safety peg 275, in accordance with an embodiment of the present invention.

FIG. 27b illustrates a detailed view of the safety strap with its hooks 277.

FIG. 27d illustrates detailed views of the safety peg.

FIG. 28a illustrates the side view of tablet computer holder comprising electrical cord 283a or 283b, base 289, base legs 280, post 282, first flexible tube 281, connector 284, second flexible tube 286, light unit 287 used to illuminate the front area of the mounting plate 285, in accordance with an embodiment of the present invention.

FIG. 28b illustrates the side view of two alternative coupling systems for connecting a flexible tube to a post: male adapter and post coupling 288a, and, pin and post port 288b.

FIG. 29 illustrates the side view of tablet computer holder comprising electrical cord 293, base 299, post 292, first mounting plate 290, dual flexible tube system 291, flexible tube 296, light unit 297 and second mounting plate 295, in accordance with an embodiment of the present invention.

### DETAILED DESCRIPTION OF THE INVENTION

What follows is a detailed description of specific embodiments of the invention in which the invention may be practiced. Reference will be made to the attached drawings, and the information included in the drawings is part of this detailed description. The specific embodiments of the invention, which will be described herein, are presented for exemplification purposes, and not for limitation purposes. It should be understood that structural and/or logical modifications could be made by someone of ordinary skills in the art without departing from the scope of the present invention. Therefore, the scope of the present invention is defined only by the accompanying claims and their equivalents.

It is to be understood that while the term tablet computer is predominantly used herein, the holder disclosed herein is designed, and therefore intended, to also accommodate smart phones and eBook readers. Hence, the terms tabled computer, smart phone, eBook reader and device are interchangeable here. Furthermore, other devices, such as a flat computer monitor or a flat TV screen, especially if comparable in terms of size and weight with a tablet computer, may be installed on the holder described herein. In addition, one of ordinary skills in the art would recognize that for larger and/or heavier devices, adjustments of the size and/or strength of the holder may need to be made, without departing from the scope of the present invention.

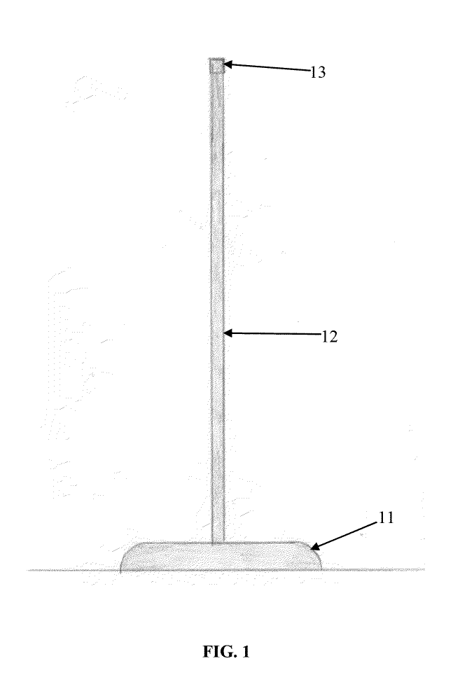

FIG. 1 illustrates the side view of a post 12 connected at its lower end to a base 11 and at its upper end to a coupling element 13, in accordance with an embodiment of the present invention. The base 11 has to be heavy and/or large enough to ensure that the entire holder is sufficiently stable when in use. However, a heavy and/or large base 11 may be inconvenient when the holder has to be moved, for example, from a room into another room. Therefore, these two considerations have to be balanced out when the right size and weight of the base are chosen. The materials for the base 11 as well as for the post 12 may be steel, aluminum, wood, plastic, etc.

The post 12 may be a tube or a rod. At its lower end, the post 12 may be irremovably attached to the base 11 (e.g., through welding), or, it can be removably attached to the base 11, as for example, by having the post 12 externally threaded and screwing it into a female nut which may be welded to the base 11. At the upper end of the post 12, a coupling element (e.g., a female coupling) 13 is attached, in order to facilitate the attachment of the flexible tube as described below. The coupling element 13 may also be attached removably (e.g., by threading/screwing) or irremovably (e.g., by welding) to the post 12.

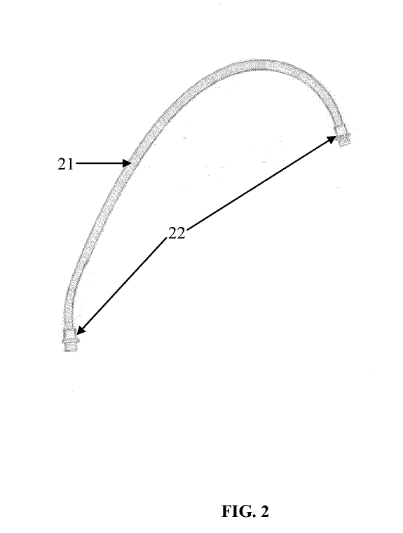

FIG. 2 illustrates the side view of a flexible tube 21 having at each end a coupling element 22, in accordance with an embodiment of the present invention. The flexible tube 21 may be any flexible tube, selected from the ones currently available on the market, or, specially designed and manufactured that would have the supporting strength necessary to safely and easily position the held device (e.g., a tablet computer) in the position desired by the user. Furthermore, it is to be noted that the supporting strength of the flexible tube 21 may be increased, if necessary, by inserting an appropriate wire in the flexible tube 21. The coupling elements 22 may be a male adapter to be used in combination with a female coupling for example. However, other coupling elements and/or coupling techniques may be used without departing from the scope of the present invention.

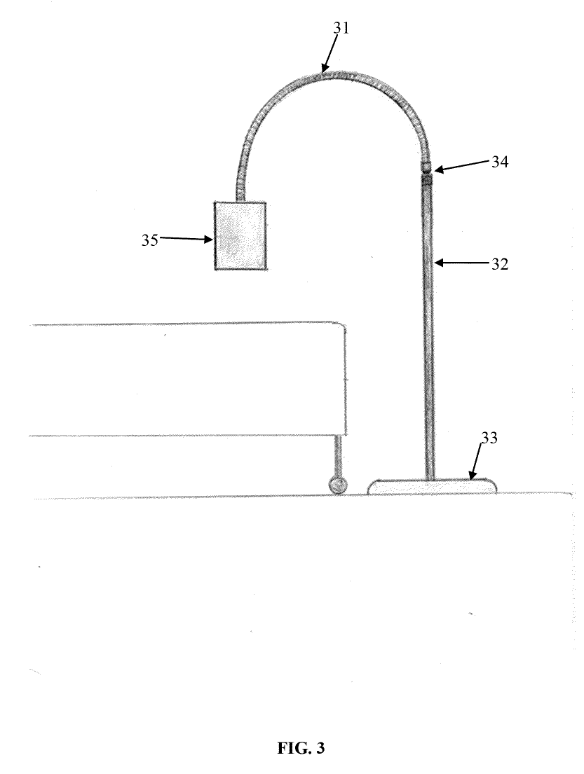

FIG. 3 illustrates the side view of a device (e.g., tablet computer) holder with its mounting plate 35, flexible tube 31, coupling system 34, post 32 and base 33, in a sample user environment (i.e., bed proximity), in accordance with an embodiment of the present invention. Again, the coupling system 34 may comprise a male adapter mounted at the end of the flexible tube 31 and a female coupling mounted at the end of post 32. However, other coupling systems and/or coupling techniques may be used without departing from the scope of the present invention. The mounting plate 35 can be made of materials such as metal, wood or plastic. On the mounting plate 35 the device (e.g., a tablet computer) is installed as described later in this disclosure.

The use of a flexible tube 31 in the structure of the holder is motivated by the objective of giving the user full range of options for positioning the mounting plate 35, and therefore, of the device installed on it. Because of the flexible tube 31, the user can quickly and conveniently move the mounting plate 35, with the device on it, up, down, left, right, forward, backward, or a combination thereof, as necessary for a proper viewing of the device. Furthermore, while other technical solutions may be employed, which may be achieving similar results, the use of the flexible tube 31 is advantageous as it is a relatively inexpensive solution while giving the user, practically, an unlimited range of motion/positioning of the device.

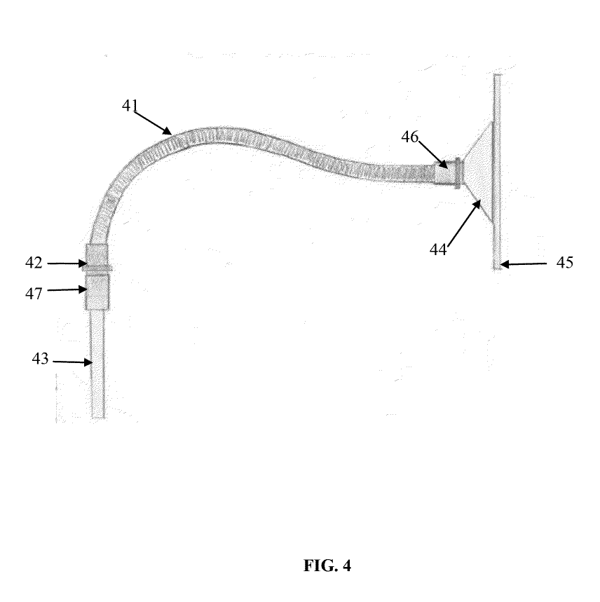

FIG. 4 illustrates the side view of flexible tube 41, with a coupling element 42 connected to pin 43 through its coupling element 47, at one end, and, at the other end of the flexible tube 41, a coupling element 46 connected to mounting plate 45 through connector 44, in accordance with an embodiment of the present invention. The connector 44 connects flexible tube 41 to mounting plate 45. Thus, the connector 44 may be called the tube-to-plate connector. It may be manufactured together with the mounting plate 45, as one piece, from materials such as plastic. The connector 44 may have at one end a threaded hole, or, for example, a female nut welded to it, for use in combination with the coupling element (e.g., male adapter) 46 attached to the flexible tube. At the other end, the connector 44 is attached to the mounting plate 45 irremovably (e.g., by welding) or removably (e.g., by using screws).

The coupling element 42 may be a male adapter to work with coupling element 47, which may be a female coupling. The coupling element 47 may be attached to pin 43 irremovably (e.g., by welding) or removably (e.g., by screwing). The purpose of the pin 43 is to facilitate a quick connection of the flexible tube 41 with, for example, a post, a wall port, or a desk port, by simply inserting it into the hollow portion of, for example, the tube or pipe of which such post or ports are made. The diameter of the pin 43 may need to be correlated with the diameter of the hollow portion of the post or ports to ensure proper stability and esthetics of the device holder. Alternatively, a second tube or pipe may be installed in the hollow portion of the post or ports to properly guide the pin 43.

The quick connect/disconnect method facilitate by the pin 43 it is advantageous to the users as they are able to expediently and conveniently move the section of the device holder depicted in FIG. 4 among, for example, a floor based post, a wall port, or a desk port. Hence, the user may have, in different spaces and or locations, several posts and/or ports, in which the pin 43 can be inserted, and therefore, the device holder may be used where needed by the user. The quick connect/disconnect method may be also an economical solution for the users as they would not need to purchase a complete device holder for any space or location where they need to use the device.

One of ordinary skills in the art would recognize that alternative quick connect/disconnect methods may be used without departing from the scope of the present invention. Furthermore, it should be understood that the pin 43 may have a threaded section corresponding to a threaded section of the post or port for securing the pin in place, to avoid, for example, unwanted rotational movements of the pin 43 or of the device holder. Other securing techniques of the pin 43 may be used without departing from the scope of the present invention. In addition, it should be noted that the coupling element 42, the coupling element 47 and pin 43 may be combined into and manufactured as one piece, and then, for example, compressed to flexible tube 41.

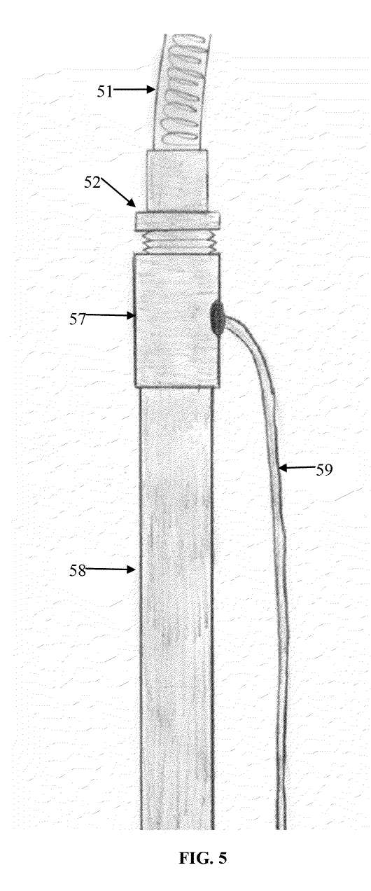

FIG. 5 illustrates the partial side view of a device (e.g., tablet computer) holder including flexible tube 51, coupling elements 52 and 57, post 58 and electrical cord 59, in accordance with an embodiment of the present invention. The electrical cord 59 may be used to power a light used to illuminate the device, as described later in this disclosure, and/or to power a device battery charger and/or one or more speakers. The electrical cord 59 may pass through coupling element 57, coupling element 52, and flexible tube 51 to arrive at the device mounting plate. Also, a second, separate wire may be passed through the same route as above to be used for the device battery charger and/or one or more speakers.

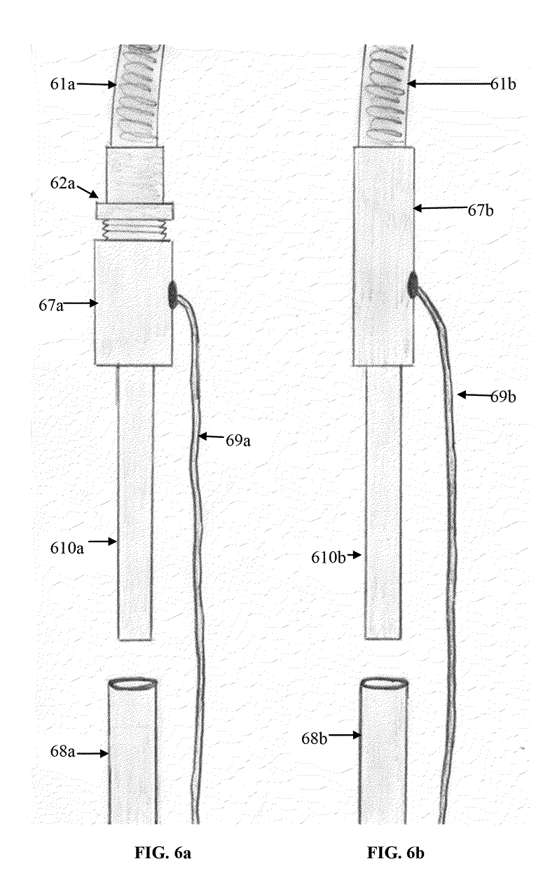

FIGS. 6a and 6b illustrate alternative coupling methods of a tablet computer holder (partial view) with flexible tubes 61a and 61b, coupling elements 62a, 67a and 67b, electrical cords 69a and 69b, pins 610a and 610b, and, tubes 68a and 68b, in accordance with several embodiments of the present invention. Again, as described earlier, the coupling element 62a, the coupling element 67a and pin 610a may be combined into and manufactured (e.g., by casting iron into a mold) as one piece (67b and 610b together), and then, for example, compressed to flexible tube 61b.

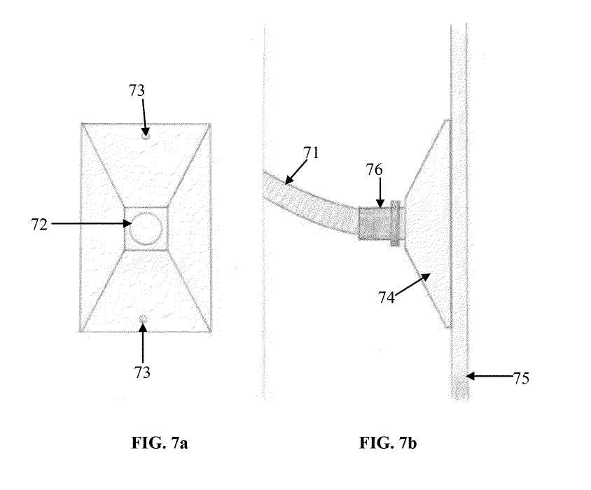

FIG. 7a and FIG. 7b illustrate a partial side view of a flexible tube 71 connected to mounting plate 75 through connector 74 and coupling element 76, and, a back view of connector 74 with its own coupling element 72 and holes 73, in accordance with an embodiment of the present invention. The holes 73 may be used to removably attach connector 74 to device mounting plate 75 by using screws and corresponding threaded holes in the mounting plate 75. The coupling element 72 may be a threaded hole or a female nut to accommodate the male adapter 76.

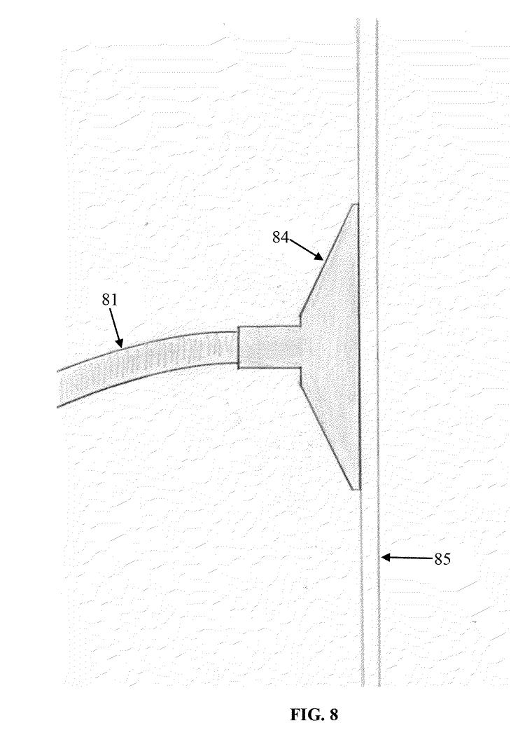

FIG. 8 illustrate a partial side view of a flexible tube 81 connected to mounting plate 85 through a one-piece connector 84, in accordance with an embodiment of the present invention. The one-piece connector 84 may be manufactured from different materials and using different techniques such as by casting iron or injecting plastic into a mold. Some of the advantages of the one-piece connector 84 may be the low cost of production and faster assembly of the entire device holder when received by the user.

As mentioned earlier, the connector 84 may be manufactured together with the mounting plate 85, as one piece, from materials such as plastic, and it may have an embedded coupling element of which to attach a coupling element of flexible tube 81. The connector 84 may be completely made out of metal and compressed on to the flexible tube 81. However, the connector 84 may be made out of plastic if it has an embedded coupling element.

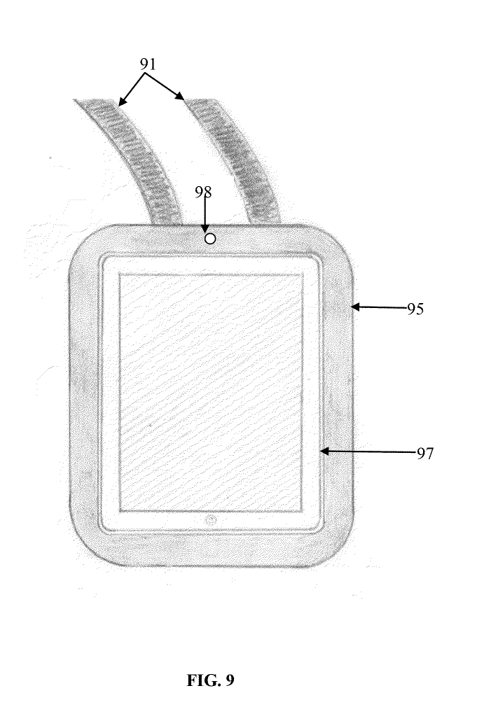

FIG. 9 illustrates the front view of a device (e.g., tablet computer) 97 attached to a mounting plate 95 having a safety hole 98, and being connected to two flexible tubes 91, in accordance with an embodiment of the present invention. The use of two flexible tubes 91, instead of a single flexible tube, as part of the device (e.g., tablet computer) holder, may be preferred when a single flexible tube may not provide the supportive strength necessary for a particular device. In addition, the use of the two flexible tubes 91 may be preferred for esthetical reasons. One of ordinary skills in the art would recognize that also three, four or more flexible tubes may be used without departing from the scope of the present invention. The safety hole 98 is made in the device mounting plate 95 to be used for the insertion of a safety peg (described later). This would prevent a device 97 attached to the mounting plate 95 using, for example, a tongue and groove system, such as when the device 97 would be sliding in from the top, to fall in the eventuality that, accidentally, the mounting plate 95 would turn upside down.

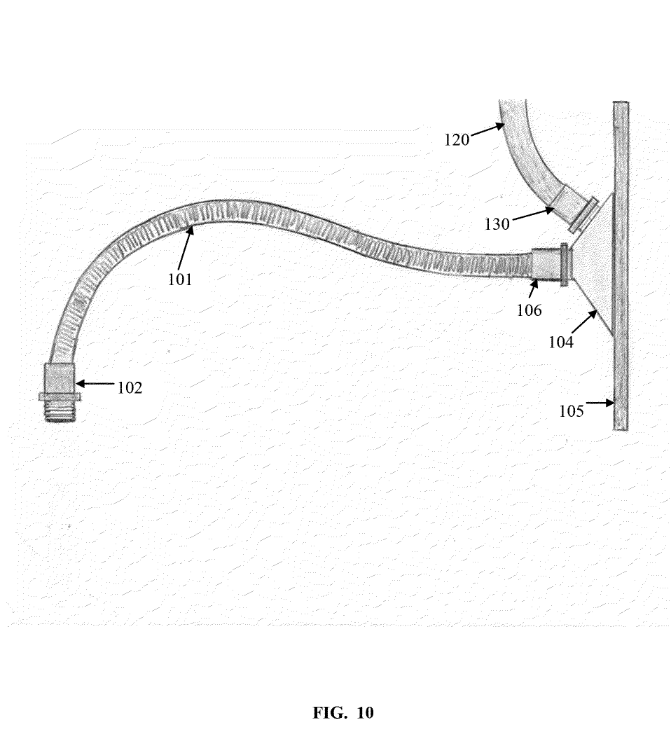

FIG. 10 illustrates the side view of flexible tube 101, with a coupling elements 102 at one end, and, at the other end, a coupling element 106 connected to mounting plate 105 through connector 104 to which a second flexible tube (partial view) 120 is connected through coupling element 130, in accordance with an embodiment of the present invention. In a device holder using a single flexible tube 101, a second flexible tube 120 may be attached to connector 104 for the purpose of running one or more wires through it, for, for example, supplying with electrical power a lighting device, which may be used to illuminate the tablet computer or other such device attached to the mounting plate 105. The second flexible tube 120 may be attached to the connector 104 the same way the flexible tube 101 is attached (e.g., male adapter and female nut).

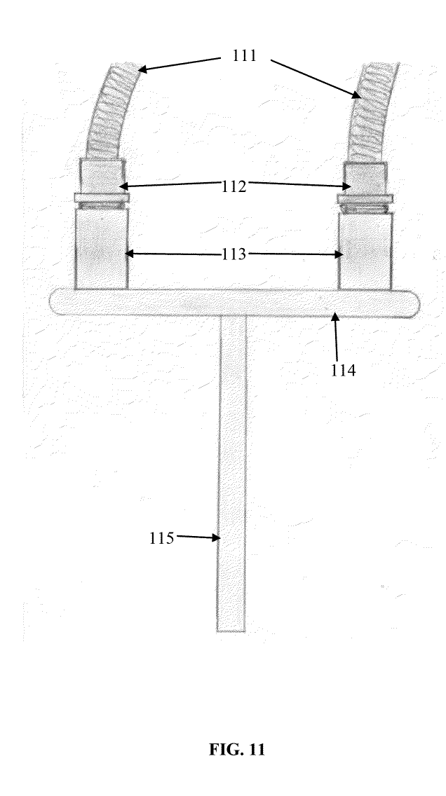

FIG. 11 illustrates the partial side view of a dual flexible tube holder, wherein the flexible tubes 111 connect to a mounting plate 114 through coupling elements 112 and 113, the mounting plate 114 being connected to a pin 115, in accordance with an embodiment of the present invention. When a holder with two flexible tubes 111 is needed and/or preferred for the reasons outlined earlier, and also a quick connect/disconnect system is desired, the structure depicted in this figure may be used. Alternatively, each of the flexible tubes 111 may be attached to its own pin 115. In such a case, a two ports base will be needed to accommodate the two separate pins. The coupling elements 113 may be female couplings and they may be attached irremovably (e.g., by welding) from mounting plate 114 or removably (e.g., by bolting them through holes made in the mounting plate 114).

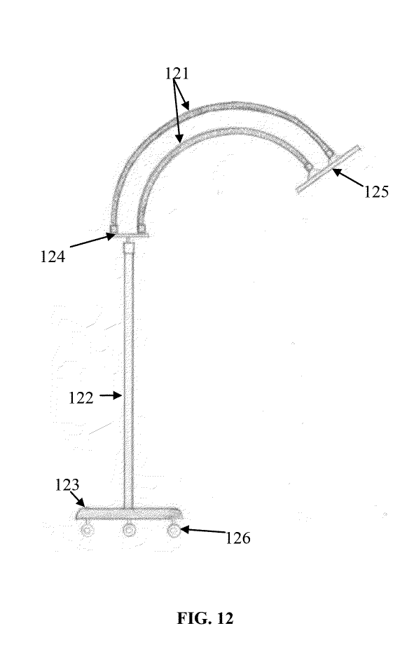

FIG. 12 illustrates the side view of a device (e.g., tablet computer holder) comprising the dual flexible tube system 121 connected to a first mounting plate 125 (i.e., for holding the tablet computer) and a second mounting plate 124 (i.e., for connection to the post 122), post 122, base 123 and wheels 126, in accordance with an embodiment of the present invention. The second mounting plate 124 may have a pin, which may be quickly inserted in the hollow post 122 (i.e., quick connect/disconnect described earlier). Other methods for attaching the second mounting plate 124 to the post 122 may be used, such as welding and/or screwing. Three or more wheels 126 may be installed at the bottom of base 123 in order to facilitate moving the device holder around the room as needed by the user.

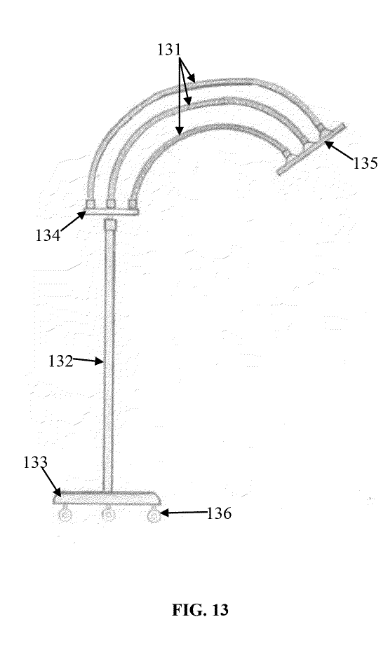

FIG. 13 illustrates the side view of a device (e.g., tablet computer holder) comprising the triple flexible tube system 131 connected to a first mounting plate 135 (i.e., for holding the tablet computer) and a second mounting plate 134 (i.e., for connection to the post 132), post 132, base 133 and wheels 136, in accordance with an embodiment of the present invention. Again, as mentioned earlier, the use of a plurality (e.g., three) of flexible tubes 131 may be needed for, for example, correlating the supporting strength of the device holder with the size and/or weight of the device.

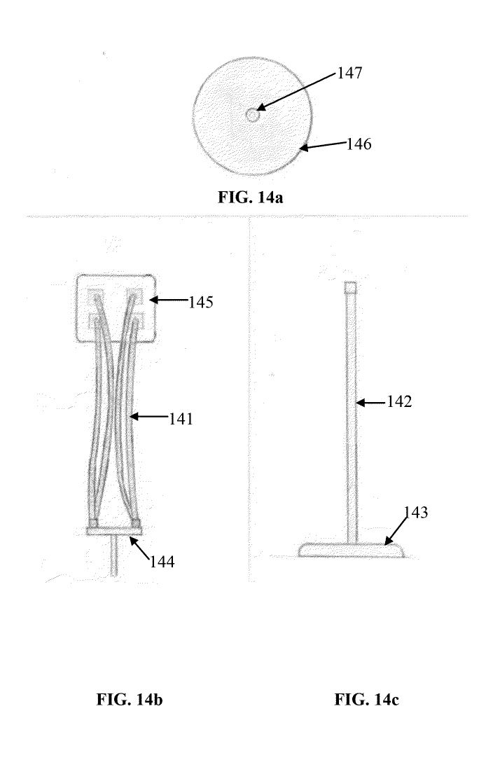

FIGS. 14a, 14b and 14c illustrate the partial back view of a tablet computer holder (i.e., FIG. 14b) comprising the quadruple flexible tube system 141 connected to a first mounting plate 145 (i.e., for holding the tablet computer) and a second mounting plate 144 (i.e., for connection to the post 142), post 142 and base 143 (i.e., FIG. 14c), and, a top view (i.e., FIG. 14a) of base 146 and post 147, in accordance with an embodiment of the present invention.

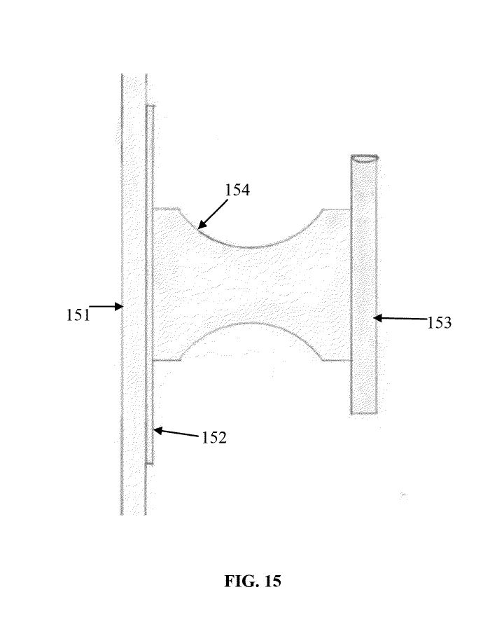

FIG. 15 illustrates the side view of a base for a tablet computer holder to be used on a wall 151, the holder comprising wall mounting plate 152, vertical connector 154 and tube 153, in accordance with an embodiment of the present invention. The pin described earlier as being connected to the flexible tube(s) (see FIG. 4 for example) may be inserted in the tube 153, which therefore, acts as a port. By doing so, the floor version (see FIG. 12 for example) of the device holder may be quickly converted into a wall version. The wall version of the device holder may be preferred by the users, in certain spaces, such as small rooms, rooms where children are present, etc.

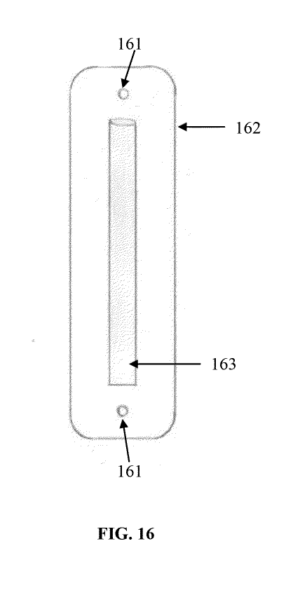

FIG. 16 illustrates the front view of a base for a device (e.g., tablet computer) holder, to be used on a wall, comprising wall mounting plate 162 with mounting holes 161 and tube 163, in accordance with an embodiment of the present invention. Using the mounting holes 161 and appropriate screws, the wall base of the device holder may be secured to the wall.

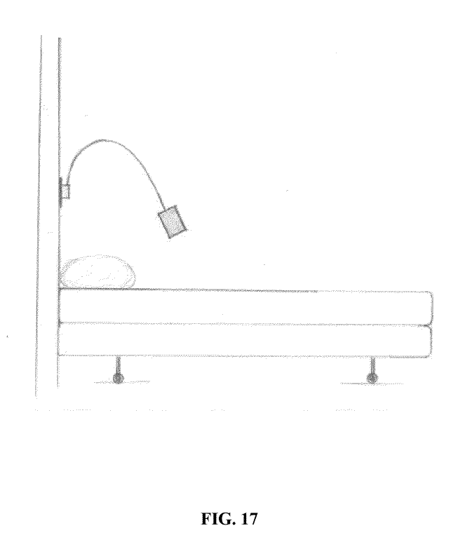

FIG. 17 illustrates a sample user environment (i.e., bedroom) where a wall version of the device (e.g., tablet computer) holder may be used.

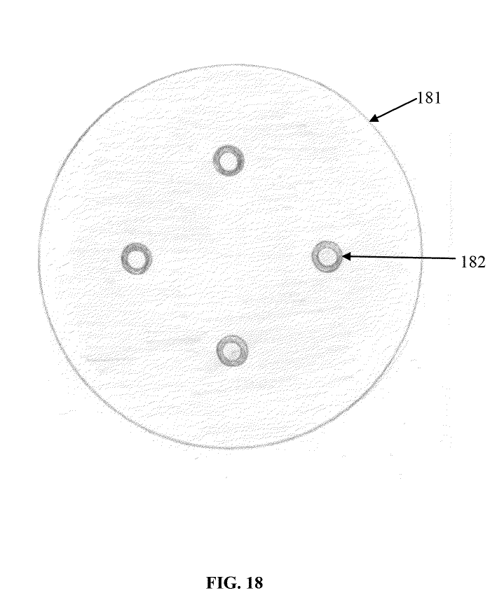

FIG. 18 illustrates the top view of a desk and table top port station 181 for the device (e.g., tablet computer) holder, designed with four ports 182 to accommodate four flexible tubes, in accordance with an embodiment of the present invention. The port station 181 may be available with 1-6 ports and may be made only for a device holder with a single tube. Hence, each port may accommodate a flexible tube supporting a particular device such as smart phone or tablet computer.

As discussed earlier, the use of a plurality of flexible tubes to support a single device may sometimes be needed and/or preferred. Such a need may be more apparent for a desk or table-top version of the device holder, as more supporting strength may be needed. For example, two, three or four flexible tubes may be used. In such a case, the ports 182 will accommodate the four flexible tubes through direct insertion of the flexible tubes into the ports, or, by the insertion into the ports of a pin which was previously attached to each of the four flexible tubes (this means four total pins), as described earlier (see FIG. 4 for example). In each case, the respective diameters and heights of the ports, tubes and/or pins will have to be correlated in order to ensure proper stability of the device holder.

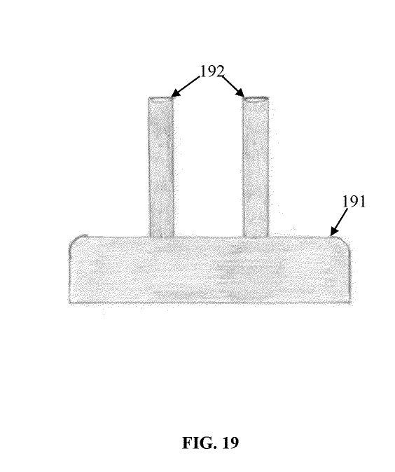

FIG. 19 illustrates the side view of a desk and table top port station with two ports 192 and base 191 in accordance with an embodiment of the present invention. The base 191 may need to be heavy and/or wide enough in order to ensure proper stability of the device holder.

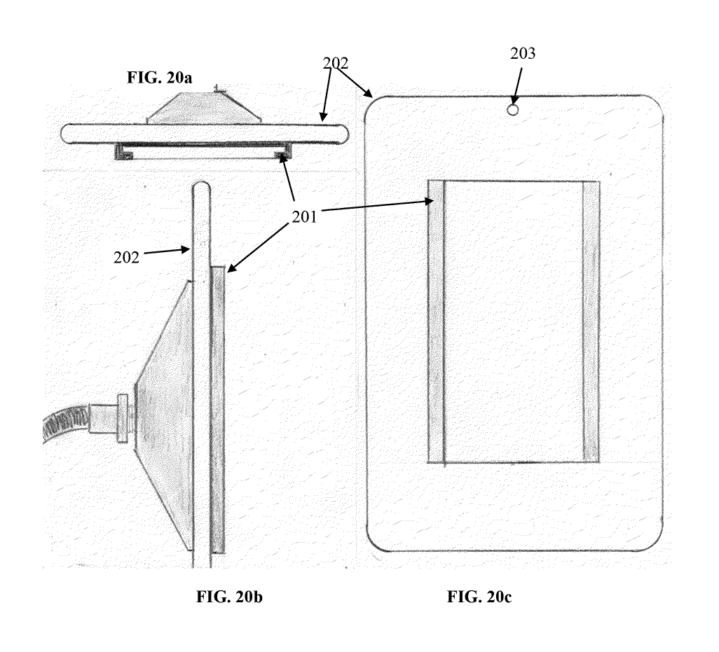

FIG. 20a (top view), FIG. 20b (side view) and FIG. 20c (front view) illustrate the groove element 201, of a tongue and groove fastening system, attached to mounting plate 202 having a safety peg mounting hole 203 for a quick and safe fastening of the tablet computer to the mounting plate 202, in accordance with an embodiment of the present invention. The tongue and groove system is advantageous as it offers a secure and relatively inexpensive way for the attachment of the device to mounting plate 202. It also offers a quick attachment/detachment of the device to/from the mounting plate 202. Quick substitution of the device (e.g., a smart phone for a tablet computer) is also possible. The groove element 201 may be irremovably attached to the mounting plate 202 by, for example, using permanent glue. It may also be manufactured as one piece together with the mounting plate 202 by, for example, injecting plastic into a mold.

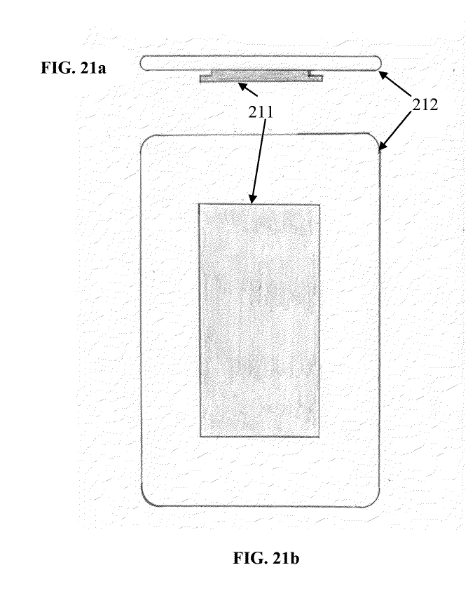

FIG. 21a (top view) and FIG. 21b (back view) illustrate the tongue element 211 of a tongue and groove fastening system attached to the back of a device (e.g., tablet computer) 212, in accordance with an embodiment of the present invention. The tongue element 211 is, preferably, permanently attached to the device 212 with, for example, an adhesive patch. The tongue element 211 may have a smooth plastic top to make it attractive. The tongue element 211 may also be used to integrate with other holding products such as an airplane seat holder, or, a car seat holder. The tongue 211 may also be attached to the device 212 removably (e.g., by using double table). Attaching the tongue 211 removably to the device 212 may be sometimes advantageous as a user would have the option to easily remove the tongue 211, which may be desirable when the device 212 is used without the device holder.

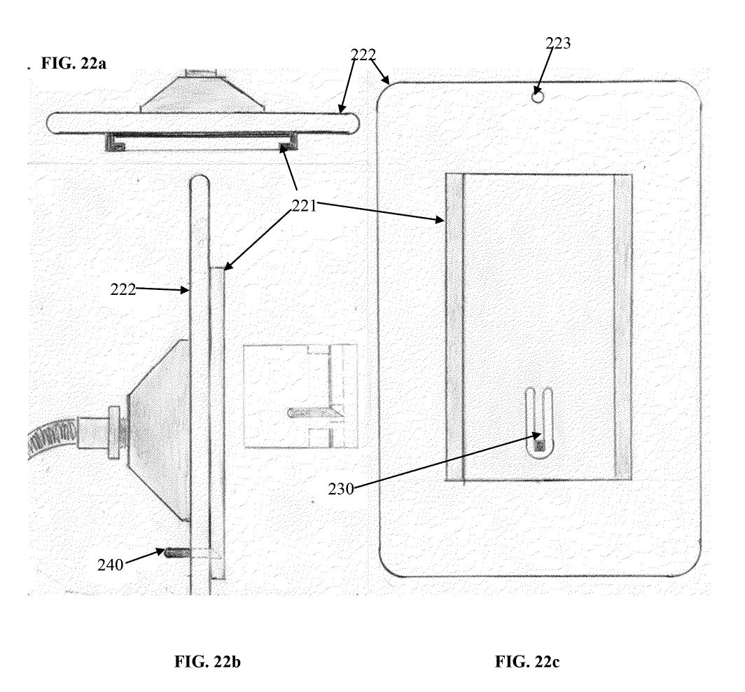

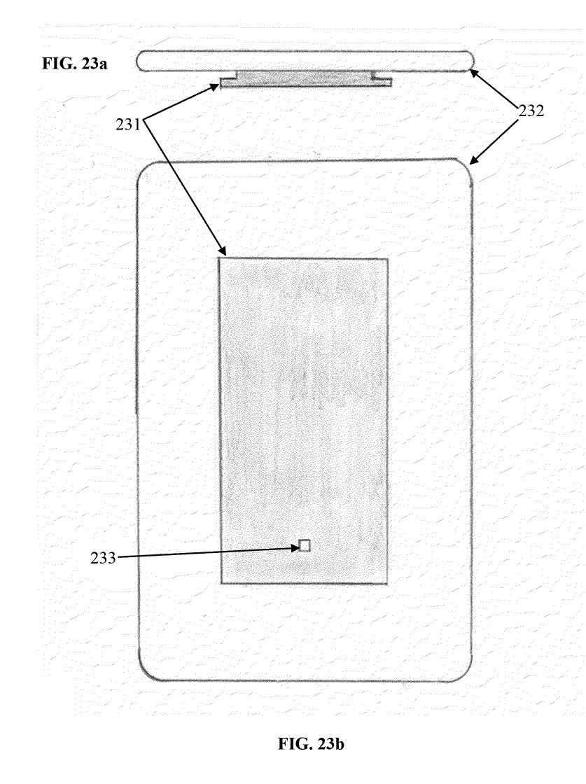

FIG. 22a (top view), FIG. 22b (side view) and FIG. 22c (front view) illustrate the groove element 221, of a tongue and groove fastening system, with self-locking retractable peg arm 230 and peg 240, and attached to mounting plate 222 having a safety peg mounting hole 223, in accordance with an embodiment of the present invention. The self-locking retractable peg peg arm (“arm”) 230 is part of the groove element 221 and is has the purpose of locking the device to the mounting plate 222 by entering the hole 233 (see FIG. 23) when the tongue element 231 (see FIG. 23) slides into the groove element 221. The arm 230 is attached (e.g., by gluing it) to the peg 240, or it can be manufactured as one piece, together with the arm 230 and groove element 221. By retracting the peg 240, the arm 230 escapes from hole 233 (see FIG. 23), thus, allowing the device to be detached from the mounting plate 222.

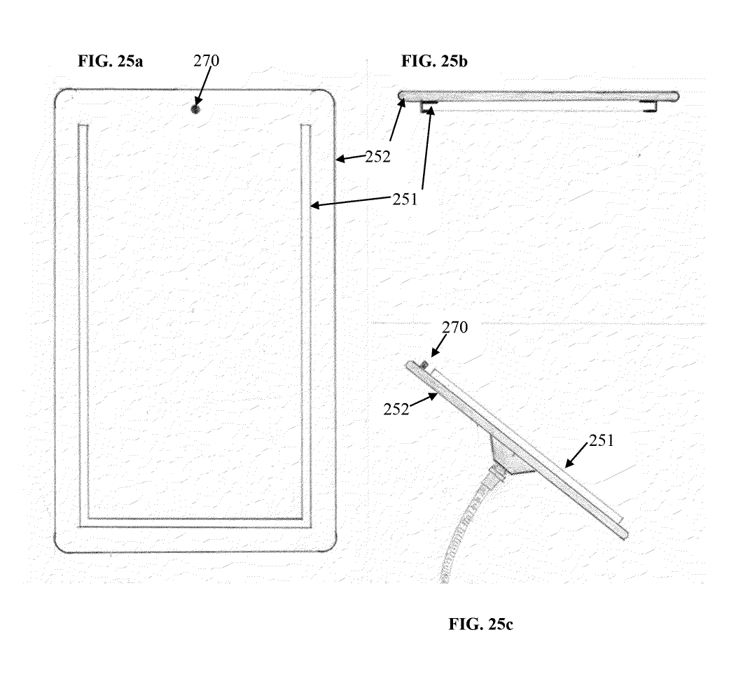

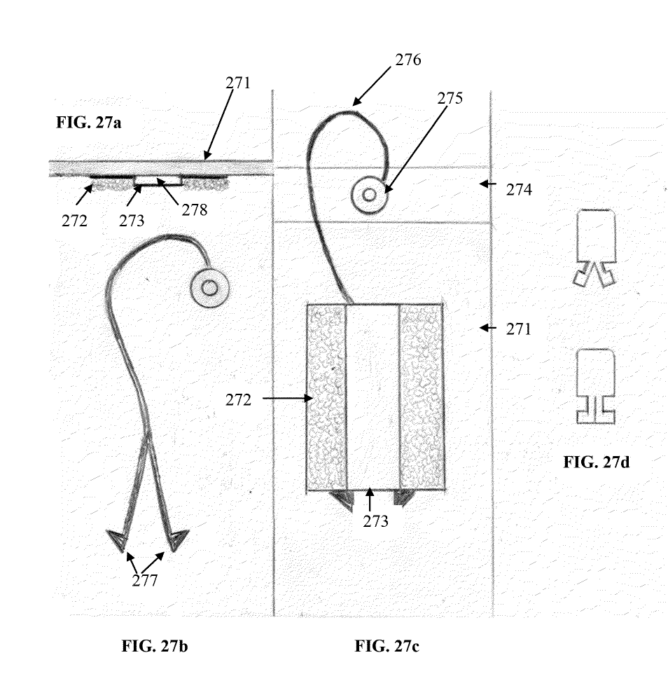

As an additional safety measure, in the safety peg mounting hole 223, a peg, as in FIG. 27d, may be inserted (see #270 in FIG. 25c). These two safety measures, designed for the purpose of ensuring that the device would not accidentally fall from the mounting plate, may be used in combination or separately. Furthermore, one of ordinary skills in the art would recognize that other safety techniques may be employed without departing from the scope of the present invention.

FIG. 23a (top view) and FIG. 23b (back view) illustrate the tongue element 231 of a tongue and groove fastening system having a retractable peg locking hole 233 and being attached to the back of a tablet computer 232, in accordance with an embodiment of the present invention. The retractable peg locking hole 233 is made in the tongue element 231, and as described earlier, helps lock the device in place when the tongue element 231, with the device attached to it, slides into the groove element 221 (see FIG. 22a).

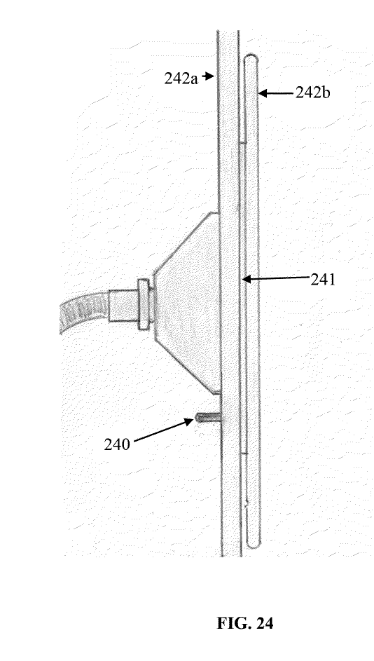

FIG. 24 illustrates the side view of a tablet computer 242b being attached to a mounting plate 242a through a tongue and groove system 241 and being secured by a self-locking retractable peg 240, in accordance with an embodiment of the present invention. Again, by pulling the peg 240 backwards, as described earlier, the tongue is released from the groove, and the device, with the tongue attached to it, may be safely removed.

FIG. 25a (front view), FIG. 25b (top view) and FIG. 25c (side view) illustrate a channel 251, for a device to be slid into, attached to mounting plate 252 which has a safety peg 270 installed, in accordance with an embodiment of the present invention. The channel 251 is, preferably, permanently attached to the mounting plate with, for example, adhesive patch. The channel 251 may be custom made to fit a particular device (e.g., a tablet computer). The channel 251 may also be removably attached (e.g., by using double tape) to the mounting plate 252. A removable attachment may be preferred when the channel 251 has fixed dimensions to accommodate only a particular device (e.g., tablet computer). A replacement of such a channel may be needed when the user whishes to use another device, and therefore a channel of an appropriate size needs to be placed on the mounting plate 252. Again, as described earlier, the safety peg 270 ensures that the device would not fall out of the channel 251 accidentally.

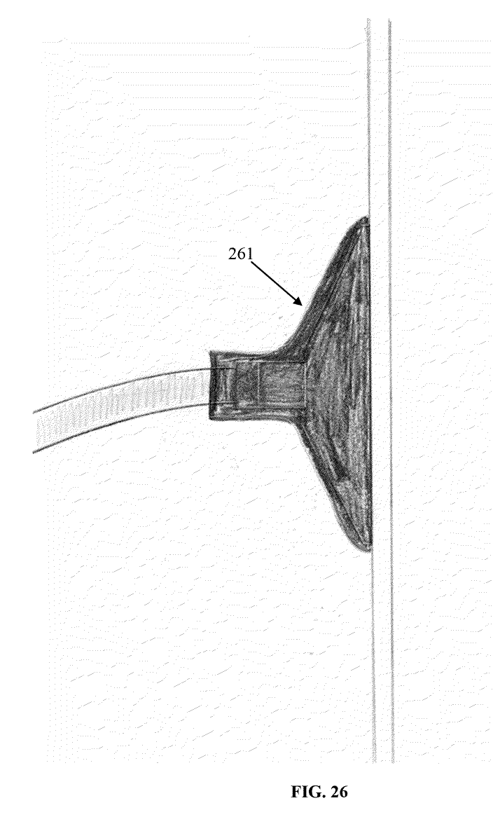

FIG. 26 illustrates the side view of a decorative rubber boot 261 for covering the tube-to-plate connector assembly (not seen), in accordance with an embodiment of the present invention. The tube-to-plate connector assembly comprising the coupling element (e.g., male adapter) 46 (see FIG. 4) and connector 44 (see FIG. 4) may be covered for, for example, esthetical reasons, with a rubber boot 261.

FIG. 27a (top view) and FIG. 27c (back view) illustrate an alternative safe attachment system for a holder of a device (e.g., tablet computer) 271 being comprised of Velcro stripes 272, sticky taped plastic sheet 273 with opening 278, safety strap 276 attached to mounting plate 274 through safety peg 275, in accordance with an embodiment of the present invention. The plastic sheet 273 may be attached to the device using, for example, sticky or double tape. The special folding applied to the plastic sheet 273 creates the opening 278 to allow the safety strap 276 tp pass between the device and the plastic sheet 273 and for the hooks 277 to attach to the bottom edge of the plastic sheet 273. The other end of the safety strap 276 is connected to the safety peg 275, which, when inserted in the hole 223 (see FIG. 22c), made in the mounting plate, secures the device 271, and prevents its fall, should the Velcro strips 272 somehow detach from the corresponding Velcro stripes on the mounting plate. The safety strap 276 and the safety peg 275 may be manufactured as a single piece.

FIG. 27b illustrates a detailed view of the safety strap with its sample hooks 277. FIG. 27d illustrates detailed views of sample safety peg.

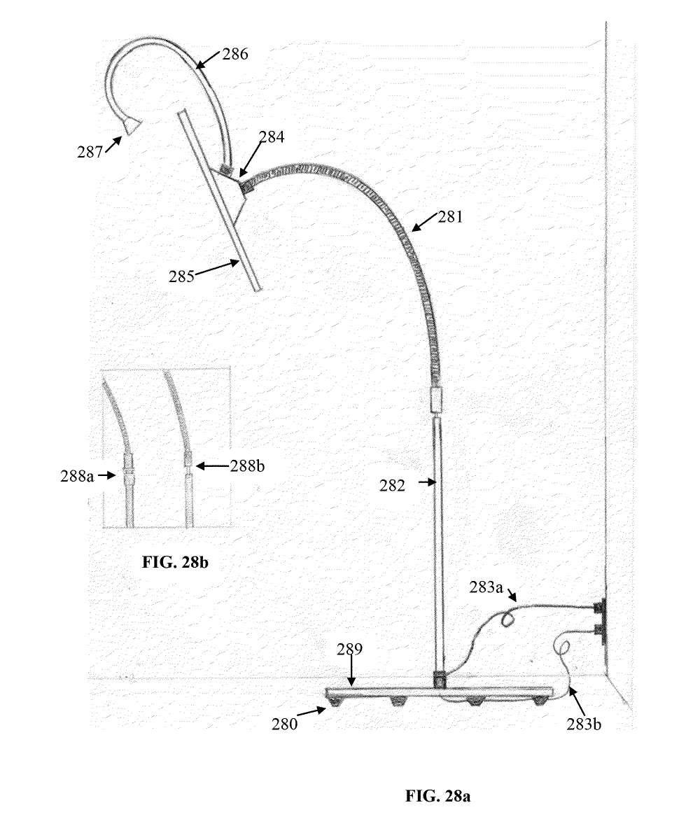

FIG. 28a illustrates the side view of device (e.g., tablet computer) holder comprising electrical cord 283a or 283b, base 289, base legs 280, post 282, first flexible tube 281, connector 284, second flexible tube 286, light unit 287 used to illuminate the front area of the mounting plate 285, in accordance with an embodiment of the present invention. The electrical cord 283a may come out from the hollow post 282 through a hole made at the bottom of the post 282 and above the base 289. Alternatively, the electrical cord 283b may come out through a hole made into the base 289. For device holders also equipped with a light, as the one depicted here, the base 289 may need to legs (e.g., rubber legs) 280, as opposed to wheels, for obvious safety reasons.

A flexible tube 286 may be used to support and position the light as desired by the user. However, one of ordinary skills in the art would recognize that other installation method for the light unit 287 may be chosen without departing from the scope of the present invention. For example, a clip-on technique or a magnetic approach (assuming the mounting plate is made of steel for example) may be used to attach the light unit to the mounting plate in the location desired by the user. What's important here is the equipping of the device holder with a light unit. This may be very important, especially for the use of the devices (e.g., eBook reader) which may not have a lit screen or for the devices with low screen luminosity level when ran on battery.

FIG. 28b illustrates the side view of two alternative coupling systems for connecting a flexible tube to a post: male adapter and post female coupling 288a, and, pin and post port 288b.

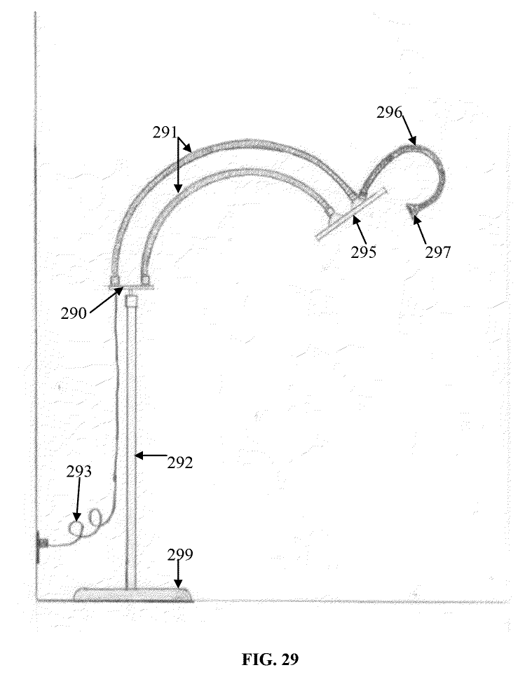

FIG. 29 illustrates the side view of a device (e.g., tablet computer) holder comprising electrical cord 293, base 299, post 292, first mounting plate 290, dual flexible tube system 291, flexible tube 296, light unit 297 and second mounting plate 295, in accordance with an embodiment of the present invention. As mentioned earlier in this description, using two or more flexible tubes 291 as part of the device holder may be needed to provide sufficient supporting strength for larger or heavier devices. However, the use of two or more flexible tubes 291 may also be selected as a design/ornamental feature of the design holder.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the present invention. Therefore, the scope of this application is intended to cover alternate embodiments and/or equivalent variations of the specific embodiments illustrated and/or described herein. Hence, the scope of the present invention is defined only by the accompanying claims and their equivalents.

What is claimed is:

1. A floor top device holder comprising a floor base, a post and a flexible tube element as a support and as a position adjustment mechanism.

2. The floor top device holder of claim 1, wherein said device is one member of the group consisting of tablet computer, eBook reader and smart phone.

3. The floor top device holder of claim 1, wherein said flexible tube element comprises one flexible tube.

4. The floor top device holder of claim 1, wherein said flexible tube element comprises a plurality of flexible tubes.

5. The floor top device holder of claim 1, further comprising a device mounting plate.

6. The floor top device holder of claim 1, further comprising a light for illuminating said device.

7. The floor top device holder of claim 1, further comprising means for attaching said device to said holder, said means comprising at least one member of the group consisting of groove, tongue, channel, and Velcro stripes.

8. The floor top device holder of claim 7, further comprising means for securing said device to said holder, said means comprising at least one member of the group consisting of safety peg, self-locking retractable peg and safety strap.

9. The floor top device holder of claim 1, further comprising means for supplying said device with electrical power.

10. A wall mounted device holder comprising a wall mounting plate, a port element and a flexible tube element as a support and as a position adjustment mechanism.

11. The wall mounted device holder of claim 10, wherein said device is one member of the group consisting of tablet computer, eBook reader and smart phone.

12. The wall mounted device holder of claim 10, wherein said flexible tube element comprises one flexible tube.

13. The wall mounted device holder of claim 10, wherein said flexible tube element comprises a plurality of flexible tubes.

14. The wall mounted device holder of claim 10, further comprising a device mounting plate.

15. The wall mounted device holder of claim 10, further comprising a light for illuminating said device.

16. The wall mounted device holder of claim 10, further comprising means for attaching said device to said holder, said means comprising at least one member of the group consisting of groove, tongue, channel, and Velcro stripes.

17. The wall mounted device holder of claim 16, further comprising means for securing said device to said holder, said means comprising at least one member of the group consisting of safety peg, self-locking retractable peg and safety strap.

18. The wall mounted device holder of claim 10, further comprising means for supplying said device with electrical power.

19. A conversion system for a device holder comprising:
means for quickly connecting and disconnecting the upper section of said holder; and,
at least one member of the group consisting of floor top port, wall port, desk port and table top port.

20. The conversion system of claim 19, wherein said device is one member of the group consisting of tablet computer, eBook reader and smart phone.
